(19) United States
(12) Patent Application Publication
(10) Pub. No.: US 2010/0295333 A1
(43) Pub. Date: Nov. 25, 2010

(54) TOP RAIL FOR A FOLDING TOP OF A PASSENGER VEHICLE

(75) Inventors: Jan Just, Bloomfield Hills, MI (US); Michael Schwarzer, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 12/784,008

(22) Filed: May 20, 2010

(30) Foreign Application Priority Data
May 20, 2009 (DE) 10 2009 022 195.6

(51) Int. Cl. B60J 7/12

(52) U.S. Cl. 296/107.16

(57) ABSTRACT

A folding top includes a roof cap extending transversely to a longitudinal direction and a top rail extending on one side of the roof cap in the longitudinal direction. The top rail has front and rear rail guides arranged end to end in the longitudinal direction with a rear end of the front rail guide facing a front end of the rear rail guide. The front rail guide is connected to the roof cap by screws. The front lever is connected to the rear end of the front rail guide. The rear lever is connected to the front end of the rear rail guide. The levers are connected together via a rotating bearing such that the rail guides are connected together and are movable relative to one another as the levers rotate about the bearing. The levers and the bearing are fabricated separately from the rail guides.

### CROSS-REFERENCE TO RELATED APPLICATIONS

This application claims foreign priority benefits under 35 U.S.C. §119(a)-(d) to DE 10 2009 022 195.6, filed May 20, 2009, which is hereby incorporated by reference in its entirety.

### BACKGROUND OF THE INVENTION

1. Field of the Invention

The present invention relates to a top rail for a convertible folding top of a passenger vehicle.

2. Background Art

U.S. Pat. No. 5,004,291 describes a movable roof for a vehicle. The movable roof has lateral roof frames and a roof cap. The roof frames are connected in a front region with the roof cap. The roof cap borders the upper windshield frame of the vehicle when the roof is in a closed position. Each lateral frame is held in place on the roof cap by screws.

DE 296 07 114 U1 describes a convertible roof for a vehicle in which a roof frame supports a foldable roof membrane provided with lateral frame components. In this connection, each front side frame part forms an interlocking system with a front roof peak part that extends transversely with respect to the direction of motion of the vehicle, with the roof peak part lying adjacent to the upper windshield frame. The roof frame is built as a lightweight construction from extruded profiles.

### SUMMARY OF THE INVENTION

An object of the present invention is a top rail for a folding roof of a passenger vehicle in which the top rail is simple to implement and manufacture and at the same time has good functionality with a high level of stability.

In carrying out the above object and other objects, the present invention provides a folding top having a roof cap and a top rail. The roof cap extends transversely to a longitudinal direction. The top rail extends on one side of the roof cap in the longitudinal direction. The top rail has a front rail guide and a rear rail guide. The front rail guide and the rear rail guide arranged end to end with one another in the longitudinal direction with a rear end of the front rail guide facing a front end of the rear rail guide. The front rail guide is connected to the roof cap by a first pair of screws. The front lever is connected to the rear end of the front rail guide. The rear lever is connected to the front end of the rear rail guide. The front and rear levers are connected together via a rotating bearing such that the rear end of the front rail guide and the front end of the rear rail guide are connected together and are movable relative to one another as the levers rotate about the rotating bearing. The front lever, the rear lever, and the rotating bearing are fabricated separately from the front and rear rail guides.

In embodiments of the present invention, a convertible top rail assembly designed for a folding top of a vehicle includes front rail guides and rear rail guides made from extruded profiles on the longitudinal sides of the folding top. The front and rear rail guides on each longitudinal side of the folding top cooperate by a respective rotating bearing through the relative motion of reversed facing end regions. In a closed position of the folding top relative to a vehicle body, the front rail guides lie next to an upper cross-member of a windshield frame of the vehicle body. The front rail guides are connected with a roof cap of the folding top which extends in a transverse direction to the longitudinal sides of the folding top. The roof cap and the rail guides are made of a light structural material. The front rail guides are held to the roof cap by first screws. Each set of front and rear rail guides are held to end regions of one another through the intermediary of levers having the rotating bearing. The levers with the rotating bearing are fabricated separately from the rail guides.

In embodiments of the present invention, a folding top includes a top cover, a roof cap, and a convertible top frame assembly. The top cover is stretched over the frame assembly. The frame assembly is movable between a closed position and an opened position. The frame assembly is movably connected to a vehicle body such that the top cover and the roof cap with the frame assembly are movable between the closed position and the opened position relative to the vehicle body along the vehicle longitudinal direction. The frame assembly includes a plurality of convertible top bows which extend transversely to the vehicle longitudinal direction. The frame assembly further includes first and second top rails which are transversely spaced apart from one another and are located on opposite longitudinal sides of the folding top. Each top rail has the same structure including a front rail guide and a rear rail guide. The front rail guide and the rear rail guide are connected together in a simple manner with the roof cap and with one another. Such connections are accomplished with screws and levers. Each top rail as assembled has a design that creates structural degrees of freedom as well as having high stability for good rigidity and movement capability. The rail guides are made, for example, from a light metal alloy and the levers are made of an iron-based metallic material, whereby a material pairing is used for these components that offers exemplary properties for a top rail of a convertible folding top. The top rail design contributes to the weight optimization of the folding top, and provides the possibility of eliminating one or more sealing elements, along with its functions of providing the actual roof shape and operating the folding top.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a perspective view of a vehicle having a folding top in accordance with an embodiment of the present invention in which the folding top is in its closed position;

FIG. 2 illustrates a perspective view of the folding top;

FIG. 3 illustrates a view of a side of the folding top;

FIG. 4 illustrates a view of the folding top in the direction of the arrow X in FIG. 3;

FIG. 5 illustrates a sectional view of a side of the folding top along the line V-V of FIG. 2;

FIG. 6 illustrates a sectional view of the same side of the folding top along the line VI-VI of FIG. 2; and

FIG. 7 illustrates a schematic representation of a view corresponding to FIG. 6.

### DETAILED DESCRIPTION OF THE PREFERRED EMBODIMENT(S)

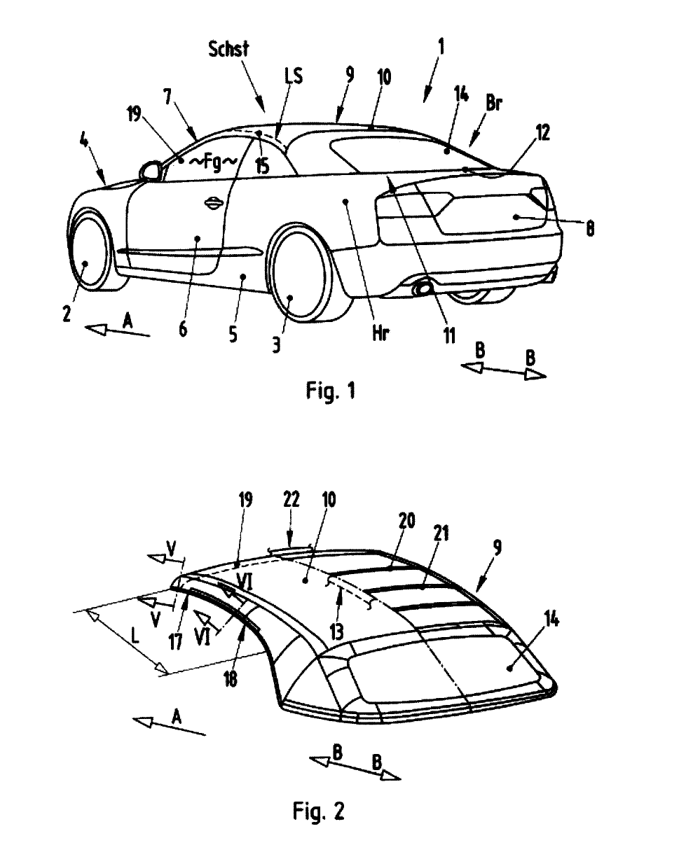

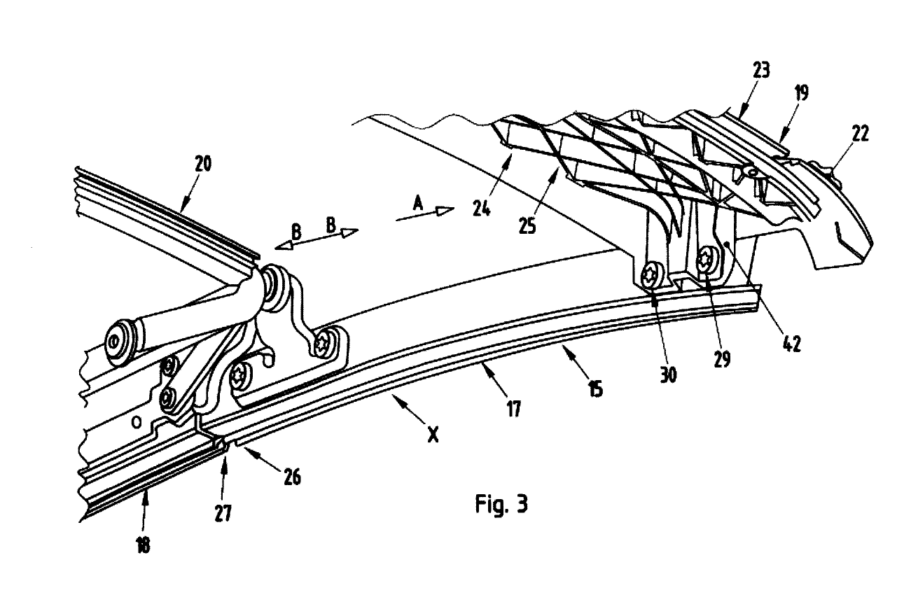

Referring now to FIG. 1, a perspective view of a passenger vehicle 1 having a folding top 9 (i.e., convertible top, collapsible top, etc.) in accordance with an embodiment of the present invention is shown. Vehicle 1 further includes a vehicle body 4 having a vehicle frame 5 that is supported by two sets of wheels 2 and 3. Vehicle body 4 includes side doors 6 which are mounted to vehicle frame 5. The front end of vehicle body 4 includes a front windshield frame 7. Windshield frame 7 has an upper cross-member 22 (labeled in FIGS. 2 and 3). Upper cross-member 22 extends transversely to vehicle longitudinal direction B-B between the longitudinal sides of vehicle body 4. The rear end of vehicle body 4 includes a trunk space Hr having an associated movable luggage compartment lid 8.

Folding top 9 is movably mounted to vehicle body 4 to move between a closed position Schst and an opened position relative to vehicle body 4. In the closed position (shown in FIG. 1), folding top 9 spans over and covers a passenger compartment Fg of vehicle body 4. In the opened position (not shown), folding top 9 is rearwardly lowered into a trunk space Hr of vehicle body 4 and stored therein.

Referring now to the remaining FIGS., with continual reference to FIG. 1, folding top 9 will be described in greater detail. Folding top 9 includes a flexible top cloth cover 10. As shown in FIG. 2, in the closed position of folding top 9, top cover 10 extends between upper cross-member 22 of windshield frame 7 and a rear section 11 of a waistline 12 adjacent luggage compartment lid 8 of vehicle body 4. Top cover 10 has a flexible interior lining 13. A rear window 14 is integrated into the rear region Br of top cover 10. Rear window 14 is made, for example, of glass, and slopes obliquely from top to bottom, opposite to the direction of forward vehicle motion A.

Folding top 9 includes a flat roof cap 19 (i.e., a folding top header, a front roof bow, etc.) in a front region of folding top 9. Roof cap 19 extends transversely to vehicle longitudinal direction B-B between the longitudinal sides of vehicle body 4. Roof cap 19 is a rigid component and borders against upper cross-member 22 of windshield frame 7 when folding top 9 is in the closed position. In this position, roof cap 19 connects with upper cross-member 22. An outer side 23 of roof cap 19 is finished smooth. An inner side 24 of roof cap 19 has reinforcing webs 25 for stiffening roof cap 19. Reinforcing webs 25 are arranged to act like a type of lattice.

Folding top 9 includes a convertible top frame assembly. The frame assembly is pivotably attached to vehicle body 4 in a rear area of folding top 9 to move folding top 9 between the closed and opened positions. The frame assembly includes a plurality of convertible top bows, for instance, first and second top bows 20 and 21. Top bows 20, 21 extend between longitudinal sides of vehicle body 4 and run transverse to vehicle longitudinal direction B-B at a distance from one another in the vehicle longitudinal direction B-B. As viewed in the direction of forward vehicle travel A, first top bow 20 lies ahead of second top bow 21. As such, first top bow 20 is a front top bow and second top bow 21 is a rear top bow.

Top cover 10 is stretched over top bows 20, 21 with the top side of top cover 10 being on an exterior side of the frame assembly and interior lining 13 being on an interior side of the frame assembly. The top side of top cover 10 faces the exterior environment of vehicle 1 when folding top 9 is in the closed position. The bottom side of interior lining 13 faces passenger compartment Fg when folding top 9 is in the closed position. Top cover 10 and interior lining 13 are spaced apart from one another with front top bow 20 extending between facing front portions of top cover 10 and interior lining 13 and rear top bow 21 extending between facing rear portions of top cover 10 and interior lining 13.

The frame assembly further includes a first top rail 15 and a second top rail (not labeled) which extend along respective longitudinal sides of vehicle body 4 in vehicle longitudinal direction B-B. Correspondingly, first top rail 15 and the second top rail are laterally spaced apart from one another on respective longitudinal sides (LS) of folding top 9. One end of each top bow 20, 21 is connected to first top rail 15 and the opposite end of each top bow 20, 21 is connected to the second top rail. Accordingly, top bows 20, 21 move as folding top 9 moves between the closed and opened positions.

First top rail 15 and the second top rail have the same structure. As such, in the interest of brevity, only first top rail 15 will be described in greater detail. First top rail 15 has a first rail guide 17 and a second rail guide 18. Each rail guide 17, 18 has a cross-section profile 16. Rail guides 17, 18 extend along vehicle longitudinal direction B-B and are arranged to lie one behind the other. In particular, as viewed in the direction of forward vehicle travel A, first rail guide 17 lies ahead of second rail guide 18. As such, first rail guide 17 is a front rail guide and second rail guide 18 is a rear rail guide.

One end of roof cap 19 is connected to front rail guide 17 of first top rail 15 and the opposite end of roof cap 19 is connected to the front rail guide of the second top rail. In particular, each end of roof cap 19 is connected by first pair of screws 29 and 30 with front rail guide 17. As described, roof cap 19 and top bows 20, 21 which are all oriented transverse to the vehicle longitudinal direction B-B. support top cover 10.

Front rail guide 17 makes use of lightweight structural materials like plastic, light metal, or the like, and can, for example, be manufactured using the extrusion technique. Rear rail guide 18 can be similarly designed. Further, roof cap 19 can also make use of such lightweight structural materials.

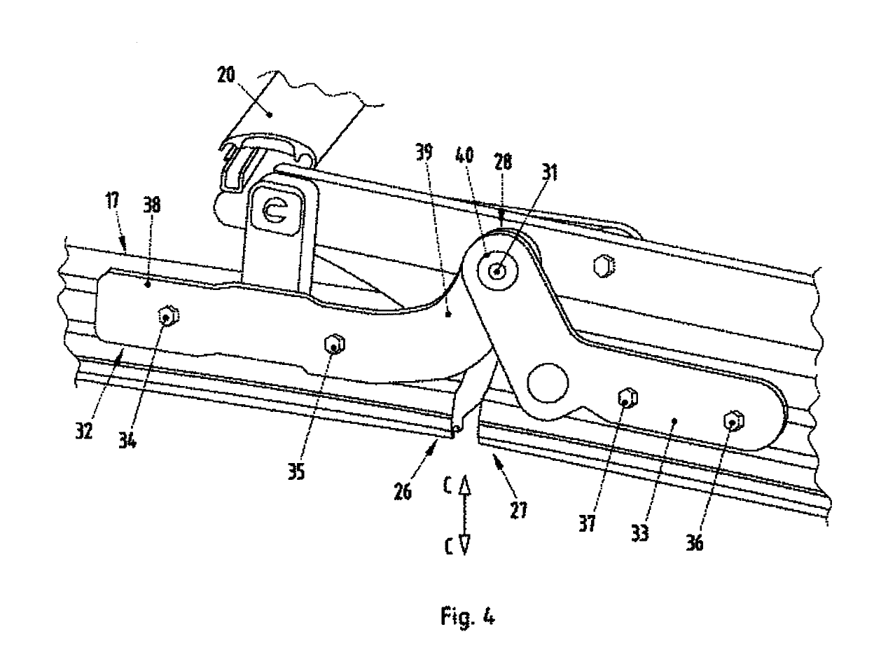

An end region 26 of front rail guide 17 and an end region 27 of rear rail guide 18 face one another as shown in FIGS. 3 and 4. At end regions 26, 27, rail guides 17, 18 act cooperatively through a rotating bearing 28 such that rail guides 17, 18 can move relative to one another.

Rotating bearing 28 is formed by a bearing pin 31, a first lever 32, and a second lever 33. Bearing pin 31, first lever 32, and second lever 33 are fabricated as separate individual parts, i.e., separate from rail guides 17, 18. First lever 32 is connected to front rail guide 17 by second pair of screws 34 and 35. Second lever 33 is connected to rear rail guide 18 by third pair of screws 36 and 37.

Each of levers 32 and 33, such as first lever 32, is formed as a two-arm lever having an attachment arm 38 and a bearing arm 39 for rotating bearing 28. In bearing arm 39, a hole 40 is made for a bearing pin 31. Bearing pin 31 extends through hole 40 and is oriented transverse to vehicle longitudinal direction B-B. Second lever 33 is made similarly so that first and second levers 32, 33 can be the same part. Each bearing arm 39 is offset compared to the corresponding attachment arm 38 such that rotating bearing 28 and bearing pin 31 vertically lie above rail guides 17, 18 as seen in the vertical direction C-C.

In an embodiment, rail guides 17, 18 are made of a light metal alloy, and levers 32, 33 are made of an iron-based metallic material. It is also possible to substitute other material pairs, for example, plastic and metal.

As shown in FIG. 3, roof cap 19 includes mounting brackets 42 integrally formed therewith. Mounting brackets 42 initially stand upright between front rail guide 17 and roof cap 19 and are used to attached front rail guide 17 to roof cap 19. First pair of screws 29, 30 are employed between mounting brackets 42 and front rail guide 17.

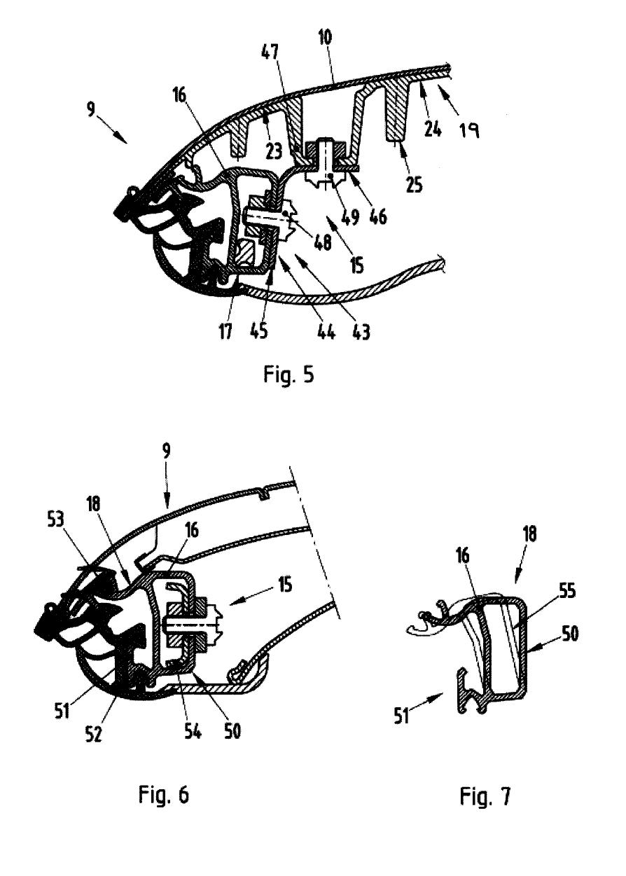

As shown in FIG. 5, a mounting bracket 43 is between front rail guide 17 and roof cap 19. Mounting bracket 43 is made of metal, plastic, or the like. Mounting bracket 43 is formed as an angular profile 44 having an upright shaped bar 45 and a horizontal shaped bar 46. Upright bar 45 supports front rail guide 17. Horizontal bar 46 supports an extension of an attachment 47 of roof cap 19. At the same time upright bar 41 and horizontal bar 42 are connected to front rail guide 17 and roof cap 19 by screws 48 and 49.

As shown in FIG. 6, rear rail guide 18, and also front rail guide 17, has a tubular section 50 and a retaining section 51. Retaining section 51 accepts sealing elements 52 and 53 of folding top 9 against which mounting parts 54 of top rail 15 are attached.

As shown in FIG. 7, rear rail guide 18, and also front rail guide 17, experiences an offset 55 through a length seen in the vehicle longitudinal direction B-B and continue in an arc.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A folding top comprising:
a roof cap extending transversely to a longitudinal direction;
a top rail extending on one side of the roof cap in the longitudinal direction, the top rail having a front rail guide and a rear rail guide, the front rail guide and the rear rail guide arranged end to end with one another in the longitudinal direction with a rear end of the front rail guide facing a front end of the rear rail guide;
wherein the front rail guide is connected to the roof cap by a first pair of screws;
a front lever connected to the rear end of the front rail guide; and
a rear lever connected to the front end of the rear rail guide;
wherein the front and rear levers are connected together via a rotating bearing such that the rear end of the front rail guide and the front end of the rear rail guide are connected together and are movable relative to one another as the levers rotate about the rotating bearing;
wherein the front lever, the rear lever, and the rotating bearing are fabricated separately from the front and rear rail guides.

2. The folding top of claim 1 wherein:
the front rail guide and the rear rail guide cooperate by the rotating bearing through the relative motion of the rear end of the front rail guide and the front end of the rear rail guide.

3. The folding top of claim 1 wherein:
the front lever is connected to the rear end of the front rail guide via a second pair of screws;
the rear lever is connected to the front end of the rear rail guide via a third pair of screws.

4. The folding top of claim 1 wherein:
each lever is a two-arm lever.

5. The folding top of claim 4 wherein:
each lever has an attachment arm and a bearing arm for the rotating bearing.

6. The folding top of claim 5 wherein:
the bearing arm is offset with respect to the attachment arm in each of the levers.

7. The folding top of claim 1 wherein:
the rotating bearing is vertically offset above the front rail guide and the rear rail guide.

8. The folding top of claim 1 wherein:
each rail guide includes a light metal and each lever includes an iron-based metallic material.

9. The folding top of claim 1 wherein:
a mounting bracket is between the front rail guide and the roof cap for fastening the front rail guide and the roof cap together.

10. The folding top of claim 9 wherein:
the mounting bracket is formed as one piece with the roof cap.

11. The folding top of claim 9 wherein:
the mounting bracket includes an angle profile having an upright shaped bar and a horizontal shaped bar.

12. The folding top of claim 11 wherein:
the upright shaped bar supports the front rail guide against which the horizontal shaped bar supports an extension of an attachment of the roof cap.

13. The folding top of claim 12 wherein:
the upright shaped bar and the horizontal shaped bar is connected to the front rail guide and the roof cap by at least one screw.

14. The folding top of claim 1 wherein:
each of the front and rear rail guides includes a tubular section and a retaining section incorporating at least one sealing element.

15. The folding top of claim 14 wherein:
each of the front and rear rail guides has an offset at least section-wise over its length.

16. The folding top of claim 14 wherein:
each of the front and rear rail guides continue in an arc over its length.

17. The folding top of claim 14 wherein:
the roof cap and the rail guides are made of a light structural material. length.

18. The folding top of claim 1 wherein:
the top rail has an extruded profile.

19. The folding top of claim 1 further comprising:
a second top rail extending on an opposite side of the roof cap in the longitudinal direction, the second top rail having a second front rail guide and a second rear rail guide, the second front rail guide and the second rear rail guide arranged end to end with one another in the longitudinal direction with a rear end of the second front rail guide facing a front end of the second rear rail guide;
wherein the second front rail guide is connected to the roof cap by screws;
a second front lever connected to the rear end of the second front rail guide; and
a second rear lever connected to the front end of the second rear rail guide;
wherein the second front and rear levers are connected together via a second rotating bearing such that the rear end of the second front rail guide and the front end of the second rear rail guide are connected together and are movable relative to one another as the second levers rotate about the second rotating bearing.

20. The folding top of claim 19 wherein:
the second front lever, the second rear lever, and the second rotating bearing are fabricated separately from the second front rail guide and the second rear rail guide.
